(19) United States
(12) Patent Application Publication
(10) Pub. No.: US 2025/0334495 A1
(43) Pub. Date: Oct. 30, 2025

(54) Material Test Apparatus

(71) Applicant: Saginomiya Seisakusho, Inc., Tokyo (JP)

(72) Inventor: Terumasa KAI, Saitama (JP)

(21) Appl. No.: 19/172,128

(22) Filed: Apr. 7, 2025

(30) Foreign Application Priority Data
Apr. 24, 2024 (JP) 2024-070468

(51) Int. Cl. G01N 3/04; G01N 3/20; G01N 3/56; G01N 19/02

(52) U.S. Cl. CPC G01N 3/04; G01N 3/20; G01N 3/56; G01N 19/02; G01N 2203/0023

(57) ABSTRACT

A material test apparatus includes a target holding portion configured to hold a test material with an elongated shape as a test target; a jig holding portion configured to hold a load-applying jig in a posture intersecting the test material, the load-applying jig having an elongated shape and being configured to apply a friction load of rubbing the test material and a bending load of bending the test material; and a movement mechanism configured to apply the friction load and the bending load from the load-applying jig to the test material by moving at least one of the target holding portion or the jig holding portion.

### CROSS-REFERENCE TO RELATED APPLICATION

This application claims the priority benefit of Japanese Patent Application No. 2024-070468 filed Apr. 24, 2024, which is fully incorporated herein by reference.

### TECHNICAL FIELD

The present invention relates to a material test apparatus configured to perform a friction test and a bending test with a test material with an elongated shape as a test target.

### BACKGROUND ART

Conventionally, a friction test and a bending test are performed with respect to an elongated test material such as a metal wire and a thread or the like as a test target. In many cases, the friction test is performed by using a test apparatus dedicated to the friction test (for example, see Patent Document 1), and the bending test is performed using a test apparatus dedicated to the bending test (for example, see Patent Document 2).

### CITATION LIST

### Patent Documents

Patent Document 1-JP 4064212B

Patent Document 2-JPH09-061327A

### SUMMARY OF THE INVENTION

### Technical Problem

Here, in a case in which the elongated materials are used by being woven in a cross pattern, both of a friction load generated by the materials rubbing with each other at intersection points and a bending load generated by the materials being bent by each other at the intersection points are applied to each of the elongated materials. In such a case, it is necessary to perform both of the friction test and the bending test to evaluate the durability thereof. At this time, when the above-mentioned friction test and the bending test are performed by using the dedicated test apparatus respectively, it is necessary to transfer the test materials between the apparatus. In this case, there is a possibility that any external factors will be introduced when transferring the test materials between the apparatus, for example, it is concerned that the test conditions vary in the case when the two tests are alternatively performed.

A purpose of the present invention is to provide a material test apparatus suitable to perform the friction test and the bending test while suppressing the change in the test condition.

### Solution to Problem

In order to solve the above-identified technical problem, the material test apparatus is characterized by including a target holding portion configured to hold a test material with an elongated shape as a test target; a jig holding portion configured to hold a load-applying jig in a posture intersecting the test material, the load-applying jig having an elongated shape and being configured to apply a friction load of rubbing the test material and a bending load of bending the test material; and a movement mechanism configured to apply the friction load and the bending load from the load-applying jig to the test material by moving at least one of the target holding portion or the jig holding portion.

According to the above-described material test apparatus, the friction test and the bending test with respect to the test materials are performed by the movement mechanism moving at least one of the target holding portion and the jig holding portion. That is, according to the above-described material test apparatus, by performing the friction test and the bending test with respect to the test materials by a single material test apparatus, it is possible to perform the friction test and the bending test while suppressing the change in the test conditions due to apparatus replacement and the like.

Here, it is preferable for the movement mechanism to apply the friction load at a load-applied point in the test material intersecting with the load-applying jig by reciprocating the jig holding portion in a friction direction along a length direction of the load-applying jig, and apply the bending load at the load-applied point in the test material by moving the load-applying jig held by the jig holding portion, at least in a load-side intersection portion thereof intersecting the test material, in a bending direction intersecting both the length direction and the friction direction of the test material.

According to this configuration, the friction test and the bending test are performed at a single point as the load-applied point in the test material such that change in the test conditions can be further suppressed.

Also, it is preferable for the movement mechanism to include a movement mechanism for friction configured to reciprocate the jig holding portion in the friction direction; and an overall movement mechanism for bending configured to move the whole load-applying jig by moving the jig holding portion in the bending direction by each movement mechanism for friction.

According to this configuration, by providing the configuration to apply the bending load by moving the whole load-applying jig for each jig holding portion and the movement mechanism for friction, it is possible to achieve a reduction in the manufacturing cost due to simplification of the mechanism.

Also, it is preferable for the movement mechanism to include a movement mechanism for friction configured to reciprocate the jig holding portion in the friction direction; and a partial movement mechanism for bending configured to partially move only the load-side intersection portion in the load-applying jig in the bending direction.

According to this configuration, by providing the configuration in which the partial movement mechanism for bending partially moves the load-side intersection portion only, it is possible to realize the miniaturization of the apparatus as the mechanical portion to be operated during the bending test.

Furthermore, it is preferable that the movement mechanism is configured to apply the friction load at a load-applied point for friction in the test material intersecting with the load-applying jig by reciprocating the jig holding portion in a friction direction along a length direction of the load-applying jig, and apply the bending load at a load-applied point for bending in the test material by at least moving a load-side intersection portion, in the load-applying jig held by the jig holding portion, intersecting with the test material such that the load-side intersection portion extends in an intersection extension direction that intersects with both the length direction of the test material and the friction direction, and then moving the load-side intersection portion in a bending direction along the friction direction.

According to this configuration, either of the friction direction and the bending direction is along the length direction of the load-applying jig such that the movement mechanism is simplified, and it is possible to realize the miniaturization of the apparatus.

Also, it is preferable that the movement mechanism includes a deformation movement mechanism configured to deform the load-applying jig to move the load-side intersection portion such that the load-side intersection portion extends in the intersection extension direction; and a common movement mechanism configured to reciprocate the jig holding portion in the friction direction when applying the friction load as well as move the jig holding portion in the bending direction after the load-side intersection portion has moved and when applying the bending load.

According to this configuration, the reciprocating movement in the friction direction and the movement in the bending direction are performed by the common mechanism such that it is possible to achieve a reduction in the manufacturing cost due to the simplification of the mechanism.

### Effect of the Invention

According to the above-described material test apparatus, it is possible to perform the friction test and the bending test while suppressing the changes in the test conditions.

### BRIEF DESCRIPTION OF THE DRAWINGS

FIG. 1 is a schematic view showing a material test apparatus according to a first embodiment.

FIG. 2 is a schematic view that is viewed from a direction of arrow V11 in FIG. 1, showing a situation in which a friction load is applied from a load-applying jig to a test material in the material test apparatus shown in FIG. 1.

FIG. 3 is a schematic view showing another example with respect to the aspect of applying the friction load as shown in FIG. 2.

FIG. 4 is a schematic perspective view similar to that of FIG. 1 showing an aspect of applying the bending load from the load-applying jig to the test material in the material test apparatus shown in FIG. 1.

FIG. 5 is a schematic view showing an aspect of applying the bending load shown in FIG. 4 when viewed from the direction of arrow V12 in FIG. 4.

FIG. 6 is a schematic view showing a test material apparatus according to a second embodiment by focusing on a situation of applying a bending load from the load-applying jig to a test material.

FIG. 7 is a schematic view showing the aspect of applying the bending load shown in FIG. 6, when viewed from the direction of arrow V21 in FIG. 6.

FIG. 8 is a schematic view showing a test material apparatus according to a third embodiment by focusing on a mechanism relating to applying a bending load from the load-applying jig to a test material.

FIG. 9 is a schematic view showing a movement of the load-side intersection portion due to the deformation of the load-applying jig shown in FIG. 8.

FIG. 10 is a schematic view showing a movement of a deformation movement mechanism for performing the deformation and movement shown in FIG. 9

FIG. 11 is a view showing an aspect of applying the bending load by a common movement mechanism in the material test apparatus shown in FIG. 8, using the same schematic perspective view with FIG. 8.

FIG. 12 is a schematic view showing an aspect of applying the bending load shown in FIG. 11, when viewed from a direction of arrow V31 in FIG. 11.

### DESCRIPTION OF EMBODIMENTS

Hereinafter, a material test apparatus according to an embodiment of the present invention will be described. At first, a first embodiment will be described.

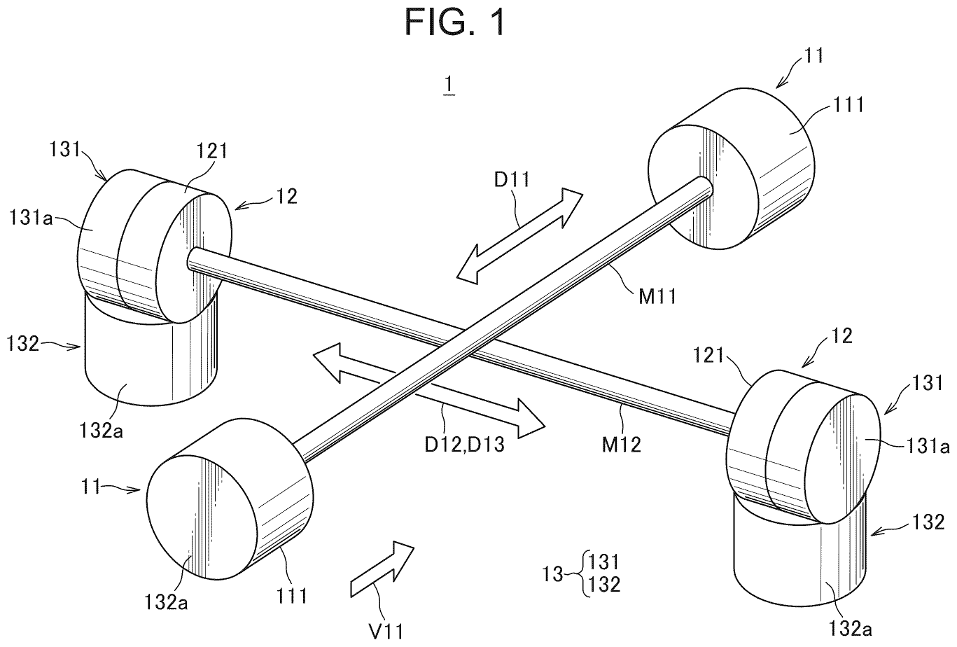

FIG. 1 is a schematic view showing a material test apparatus according to a first embodiment.

A material test apparatus 1 according to the present embodiment is an apparatus configured to perform a friction test and a bending test with respect to an elongated test material M11 as a test target, and includes a target holding portion 11, a jig holding portion 12, and a movement mechanism 13. The target holding portion 11 is a portion configured to hold the elongated test material M11, such as a metal wire or a thread and the like, as the test target. This target holding portion 11 includes a pair of test-side holding portions 111 for holding both end portions of the test material M11 and also plays a role of applying a certain amount of tension by pulling the test material M11 in a length direction thereof as a target length direction D11 by the pair of test-side holding portions 111. The jig holding portion 12 is a portion configured to hold an elongated load-applying jig M12, such as the metal wire or the thread and the like, being same with that of the test material M11. The load-applying jig M12 is a jig member configured to apply the friction load while rubbing with the test material M11 and the bending load of bending the test material M11. The jig holding portion 12 includes a pair of jig-end holding portions 121 configured to hold both end portions of the load-applying jig M12, and also plays a role of applying a certain amount of tension by pulling the load-applying jig M12 in the length direction thereof as a jig length direction D12 by the pair of jig-end holding portions 121. The movement mechanism 13 is a mechanical portion configured to move at least either of the target holding portion 11 and the jig holding portion 12, according to the present embodiment, the jig holding portion 12, to apply the friction load and the bending load from the load-applying jig M12 to the test material M11.

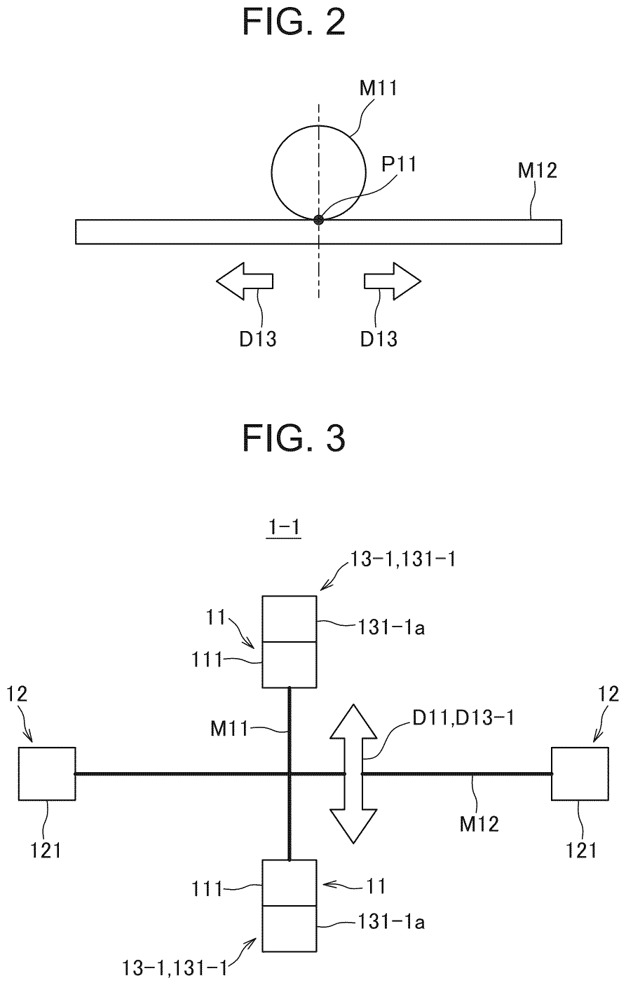

FIG. 2 is a schematic view showing an aspect where the friction load is applied from the load-applying jig to the test material in the material test apparatus shown in FIG. 1, that is viewed from a direction of arrow V11 in FIG. 1. It is noted that in FIG. 2, the test material M11, which is drawn with approximately the same thickness as that of the load-applying jig M12 in FIG. 1, is emphasized to be shown thicker than the load-applying jig M12.

At first, the movement mechanism 13 applies the friction load at a load-applied point P11 intersecting the load-applying jig M12 in the test material M11 by making the jig holding portion 12 to reciprocate in a friction direction D13 along the jig length direction D12. As shown in FIG. 1, the movement mechanism 13 includes a movement mechanism for friction 131 configured to make the jig holding portion 12 to reciprocate in the friction direction D13. This movement mechanism for friction 131 includes a pair of jig-end movement mechanism for friction 131a connected to the pair of jig-end holding portions 121 in the jig holding portion 12 respectively to make each jig-end holding portion 121 to reciprocate in the friction direction D13. According to the movement mechanism for friction 131, either of the pair of jig-end movement mechanism for friction 131a is synchronized with each other to make each jig-end holding portion 121 to reciprocate in the friction direction D13. Due to this synchronized reciprocation, the load-applying jig 12 applies the friction load by reciprocating while maintaining the tension from the jig holding portion 12 to rub with the test material M11 at the load-applied point P11.

According to the present embodiment, the friction load is applied due to the movement of the jig holding portion 12, however, as long as at least either of the test holding portion 11 and the jig holding portion 12 is moved, another aspect shown below may be made.

FIG. 3 is a schematic view showing another example regarding an aspect of applying the friction load shown in FIG. 2. In this FIG. 3, the configuration elements equivalent to the configuration elements shown in FIG. 1 and FIG. 2 are designated with the same reference signs in FIG. 1 and FIG. 2, and hereafter, the redundant description for these equivalent configuration elements will be omitted.

According to another example of the material test apparatus 1-1 shown in this FIG. 3, a movement mechanism 13-1 applies the friction load due to the movement of the target holding portion 11 between the target holding portion 11 and the jig holding portion 12. That is, the movement mechanism 13-1 includes a movement mechanism for friction 131-1 for making the target holding portion 11 to reciprocate in a friction direction D13-1 along the target length direction D11 of the test material M11. In this example, the movement mechanism for friction 131-1 includes a pair of test-side movement mechanism for friction 131-1a connected to the pair of test-side holding portions 111 in the target holding portion 11 in a one-to-one correspondence and to make each test-side holding portions 111 to reciprocate in the above-described friction direction D13-1. According to the movement mechanism for friction 131-1, this pair of test-side movement mechanism for friction 131-la are synchronized with each other to make each test-side holding portion 111 to reciprocate in the friction direction D13-1. Due to this synchronized movement, the test material M11 reciprocates while maintaining the tension from the target holding portion 11 and load-applied point P11 of the test material M11 (see FIG. 2) is rubbed by the load-applying jig M12 that is maintained by the pair of jig-end holding portions 121 in the jig holding portion 12 in an immobile state. Due to the rubbing, the friction load is applied at the load-applied point P11 of the test material M11.

Also, the aspect of applying the friction load is not limited to the applying aspect of moving either of the target holding portion 11 and the jig holding portion 12 as shown in the first embodiment in FIG. 1 and FIG. 2 and the other example as shown in FIG. 3, another aspect of moving both of the target holding portion 11 and the jig holding portion 12 is also available. In this case, the movement mechanism, as the movement mechanism for friction, includes both of the mechanism for making the test material M11 to reciprocate and the mechanism for making the load-applying jig M12 to reciprocate.

Next, returning to the first embodiment shown in FIG. 1 and FIG. 2, applying the bending load to the test material M11 from the load-applying jig M12 will be described.

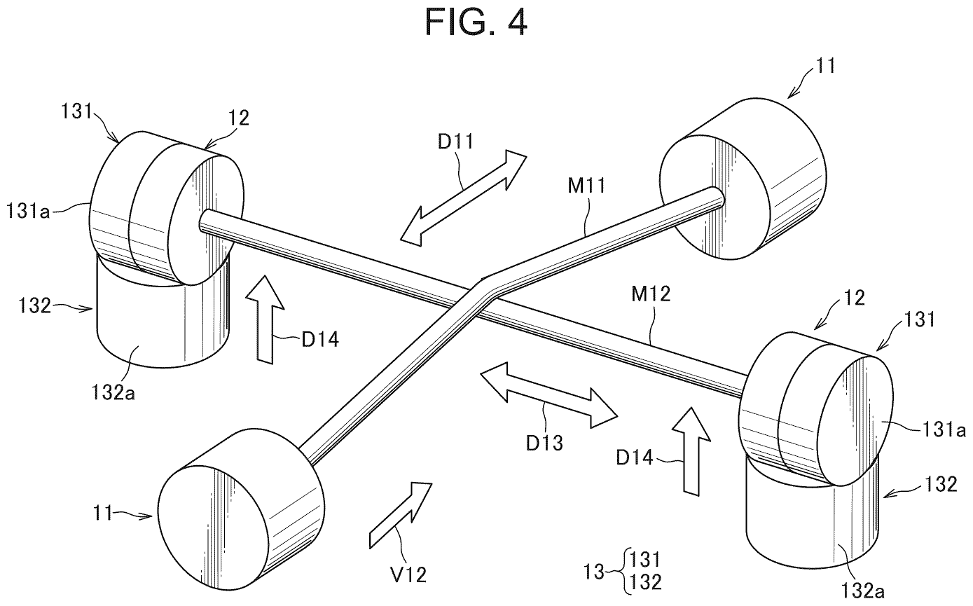

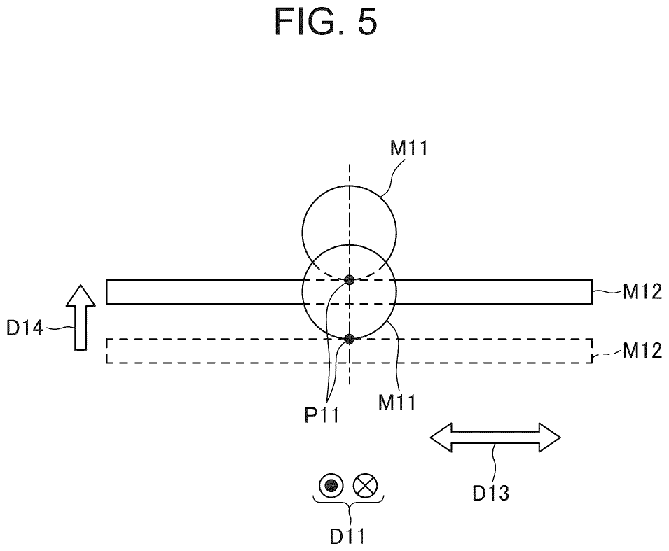

FIG. 4 is a view showing an aspect of applying the bending load from the load-applying jig to the test material in the material test apparatus shown in FIG. 1 by using a similar schematic perspective view in FIG. 1. Also, FIG. 5 is a schematic view showing the aspect of applying the bending load shown in FIG. 4 when viewed from the direction of arrow V12 in FIG. 4. It is noted that in FIG. 5, similar to the manner in FIG. 2, the test material M11 is emphasized and shown to be thicker than load-applying jig M12.

Regarding applying the bending load, the movement mechanism 13 moves the load- applying jig M12 held by the jig holding portion 12 in a bending direction D14 at least across the load-side intersection portion intersecting the test material M11, in the present embodiment, across the whole length of the load-applying jig M12. At this time, the bending direction D14 is a direction intersecting to both of the target length direction D11 of the test material M11 and the above-described friction direction D13, and in which the load-applying jig M12 presses and bends the test material M11 from the lower side in the figure. The movement mechanism 13 moves the load-applying jig M12 across the whole length thereof in the bending direction D14 such that the bending load is applied at the load-applied point P11 in the test material M11 (see FIG. 5).

Here, according to the present embodiment, the movement mechanism 13 includes, together with the movement mechanism for friction 131 configured to move the jig holding portion 12 by the pair of jig-end movement mechanism 131a, an overall movement mechanism for bending 132 configured to move the jig holding portion 12 in the bending direction D14 per each movement mechanism for friction 131. Due to the movement of the jig holding portion 12 by this overall movement mechanism for bending 132, the load-applying jig M12 moves as a whole in the bending direction D14 across the whole length thereof. The overall movement mechanism for bending 132 includes a pair of jig-end movement mechanism for bending 132a being provided in a one-to-one correspondence with the pair of jig-end holding portions 121, that is, also in the one-to-one correspondence with the pair of jig-end movement mechanism for bending 131a. According to the overall movement mechanism for bending 132, this pair of jig-end movement mechanism for bending 132a are synchronized with each other to move each jig-end holding portion 121 and the jig-end movement mechanism for friction 131a in the bending direction D14. Due to this synchronized movement, the load-applying jig M12 moves as a whole while maintaining the tension from the jig holding portion 12 and upwardly presses the load-applied point P11 of the test material M11 to apply the bending load. At the time of making the bent test material M11 to return to the original state, the pair of jig-end movement mechanism 132a are synchronized with each other to move each jig-end holding portion 121 and the jig-end movement mechanism for friction 131a in an opposite direction to the bending direction D14 to release the bending load. Furthermore, when repeating the application of the bending load and the release of the bending load to bend and stretch the test material M11, the movement in the bending direction D14 and the movement in the opposite direction are alternatively repeated.

Also, according to the present embodiment, the application of the bending load is performed by the movement of the jig holding portion 12, however, as long as at least either of the target holding portion 11 and the jig holding portion 12 is moved, another example of moving the target holding portion 11 to apply the bending load is also available. Any figures showing such example will be omitted, however, in such another example, the target holding portion 11, that is, the test material M11 is moved in the opposite direction to the bending direction D14 as shown in FIG. 4 and FIG. 5 to be abutted against the load-applying jig M12. Due to this abutting, the bending load is applied at the load-applied point P11 of the test material M11 such that the test material M11 is bent, similar to the situation in FIG. 4 and FIG. 5.

According to the material test apparatus 1 in the above-described first embodiment, the movement mechanism 13 moves the jig holding portion 12 (in FIG. 3 and the above-described another example, the target holding portion 11) to perform the friction test and the bending test with respect to the test material M11. That is, according to the above-described material test apparatus 1, by performing the friction test and the bending test with respect to the test material M11 with the single material test apparatus, it is possible to perform the friction test and the bending test while suppressing the changes in the test conditions due to apparatus replacement and the like.

Also, according to the present embodiment, by moving the jig holding portion 12, it is possible to make the load-applying jig M12 and the test material M11 to intersect at any position in the target length direction D11, and it is possible to perform the friction test and the bending test at this position as the load-applied point P11. Furthermore, the movement mechanism 13 rotates the jig holding portion 12 (that is, the load-applying jig M12) with the central axis of the test material M11 being held by the target holding portion 11, the intersection point of the test material M11 and the load-applying jig M12, that is, the load-applied point P11 can be shifted in a circumferential direction around the central axis of the test material M11. That is, according to the present embodiment, it is possible to perform the friction test and the bending test at the any load-applied point P11.

Here, according to the present embodiment, the movement mechanism 13 applies the friction load at the load-applied point P11 by making the jig holding portion 12 to reciprocate in the friction direction D13 and applies the bending load at the load-applied point P11 by moving the load-applying jig M12 in the bending direction D14 across the whole length thereof. According to this configuration, it is possible to perform the friction test and the bending test at the single load-applied point P11 in the test material M11 so as to further suppress the changes in the test conditions.

Also, according to the present embodiment, the movement mechanism 13 includes the movement mechanism for friction 131 for making the jig holding portion 12 to reciprocate and the overall movement mechanism for bending 132 for making the load-applying jig M12 to move as a whole by moving the jig holding portion 12 per each movement mechanism for friction 131. According to the present configuration, due to the configuration of applying the bending load by moving the jig holding portion 12 and the whole load-applying jig M12 per each movement mechanism for friction 131, it is possible to reduce the manufacturing cost by the simplification of the mechanism.

The above-described features can also be applied to the other examples where the application of the friction load and the bending load are performed by the movement of the target holding portion 11.

Next, a second embodiment will be described. The second embodiment is different from the first embodiment in the configuration of the mechanism for applying the bending load. Hereafter, the second embodiment will be described by focusing on the differences to the first embodiment.

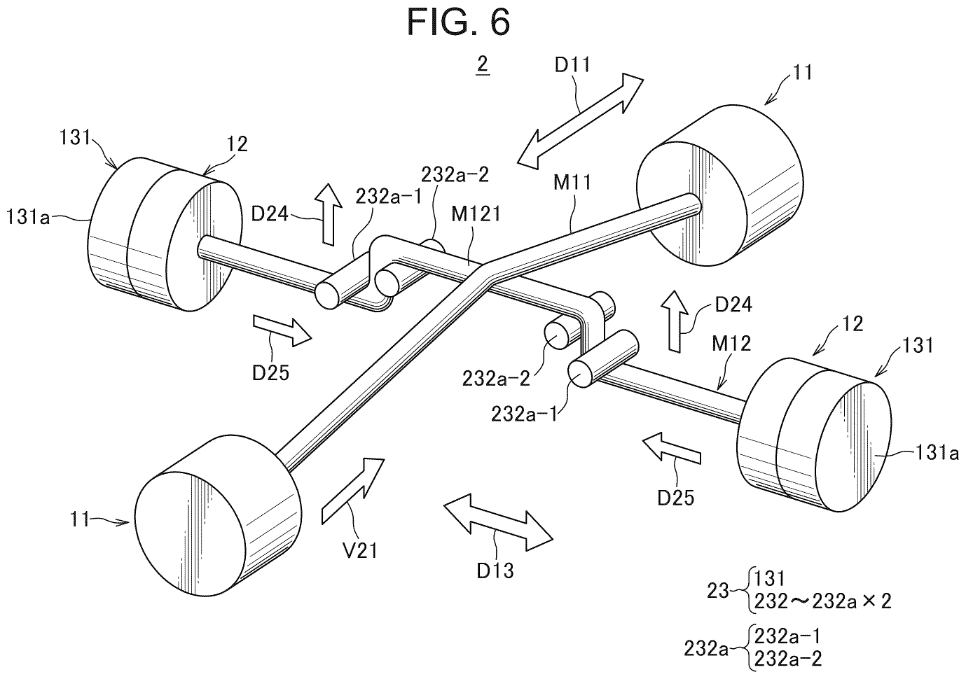

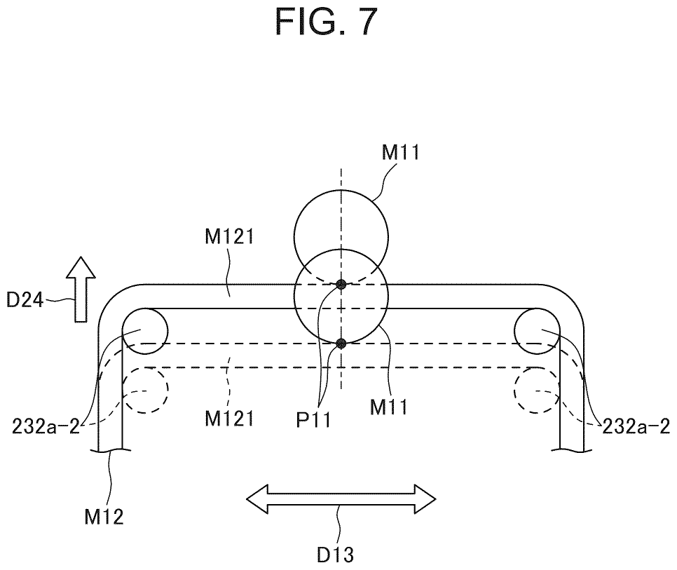

FIG. 6 is a schematic view showing a material test apparatus according to a second embodiment by focusing on a situation when a bending load is applied from a load-applying jig to a test material. Also, FIG. 7 is a schematic view showing the applying situation shown in FIG. 6 when viewed from a direction of arrow V21 in FIG. 6. It is noted that even in FIG. 7, similar to FIG. 2, the test material M11 is emphasized and shown thicker than the load-applying jig M12. Also, in FIG. 6 and FIG. 7, regarding the configuration elements being equivalent to the configuration elements shown in FIG. 1 and FIG. 2, together with FIG. 4 and FIG. 5, only those being necessary to be described will be designated to with the same reference signs in those figures, and hereinafter, the reductant description for these equivalent configuration elements will be omitted.

According to a material test apparatus 2 according to a second embodiment, regarding the aspect of applying the friction load, similar to the above-described first embodiment, the movement mechanism for friction 131 in the movement mechanism 23 is configured to make the jig holding portion 12 to reciprocate. Compared with this, the aspect of applying the bending load is different from that in the first embodiment, wherein in the load-applying jig M12, it is performed by partially moving a load-side intersection portion M121 only, which intersects to the test material M11 held by the target holding portion 11, in the bending direction D24. The movement mechanism 23 includes a partial movement mechanism for bending 232 configured to perform the partial movement of the load-side intersection portion M121 in this manner. The partial movement mechanism for bending 232 includes a pair of fulcrum mechanism 232a configured to move both end portions of the load-side intersection portion M12, and each fulcrum mechanism 232a includes a pressing fulcrum 232a-1 and a push-in fulcrum 232a-2.

The pressing fulcrum 232a-1 is a fulcrum member in a round bar shape configured to press and support an outside portion of an end portion of the load-side intersection portion M121 in the load-applying jig M12 in the opposite side of the bending direction D24 so as to make it not to move in the bending direction D24. The push-in fulcrum 232a-2 is a fulcrum member in a round bar shape configured to push in and move a portion of an inside portion of the end portion of the load-side intersection portion M121 in the bending direction D24. The pressing fulcrum 232a-1 supports the outside portion of the end portion while the push-in fulcrum 232a-2 moves in the bending direction D24 such that the end portion of the load-side intersection portion M121 moves in the bending direction such that the end portion of the load-side intersection portion M121 moves in the bending direction D24. Such movement are synchronized with each other and performed by the pair of fulcrum mechanism 232a at both end portions of the load-side intersection portion M121 such that the load-side intersection portion M121 moves in the bending direction D24.

At this time, at the outside of the end portion of the load-side intersection portion M121, the load-applying jig M12 is bent in the bending direction D24 in a state of being sandwiched by the pressing fulcrum 232a-1 and the push-in fulcrum 232a-2. Accordingly, at the outside of the end portion of the load-side intersection portion M121, the load-applying jig M12 displaces along the bending direction D24 by the movement amount of the push-in fulcrum 232a-2, that is, the movement amount of the load-side intersection portion M121. As a result, a distance between the end portions of the load-applying jig M12 is reduced. This reduction is performed by the pair of jig-end movement mechanism for friction 131a in the movement mechanism for friction 131 moving the end portions of the load-applying jig M12 to make them approach each other in an approaching direction D25 along the friction direction D13 to synchronize with the movement by the partial movement mechanism for bending 232.

According to the present embodiment, the partial movement mechanism for bending 232 makes the load-side intersection portion M121 in the bending direction D24 in this manner such that the bending load is applied to the load-applied point P11 (see FIG. 7) as the intersection point with the load-side intersection portion M121 in the test material M11. When the bent test material M11 is returned to the original state, the partial movement mechanism for bending 232 makes the load-side intersection portion M121 to move in the opposite direction of the bending direction D24 to release the bending load. At this time, the end portions of the load-applying jig M12 are separated from each other in the opposite direction of the approaching direction D25 by the pair of jig-end movement mechanism for friction 131a. When repeating the applying and releasing of the bending load to perform the bending and stretching of the test material M11 in this manner, the movement in the bending direction D24 and the approaching direction D25 and the movement in the opposite direction thereof are repeated.

According to the above-described material test apparatus 2 of the second embodiment, similar to that in the first embodiment, it is obvious that the friction test and the bending test can be performed while suppressing the changes in the test conditions due to the apparatus replacement or the like.

Also, according to the present embodiment, similar to the first embodiment, it is possible to perform the friction test and the bending test with respect to the optional load-applied point P11 in the target length direction D11 in the test material M11. Furthermore, it is possible to perform the friction test and the bending test with respect to the optional load-applied point P11 in the circumferential direction by the movement mechanism 23 rotating the jig holding portion 12 (that is, the load-applying jig M12) about the central axis of the test material M11 that is held by the target holding portion 11.

Also, according to the present embodiment, the movement mechanism 23 includes the movement mechanism for friction 131 and the partial movement mechanism for bending 232 to partially move the load-side intersection portion M121 only. According to this configuration, the partial movement mechanism for bending 232 is configured as a configuration for partially moving the load-side intersection portion M121 only such that the mechanical portions operated during the bending test can be kept to a minimum, allowing for the device to be manufactured smaller.

Next, a third embodiment will be described. The third embodiment is different from the first embodiment in the configuration of the mechanism for applying the bending load. Hereinafter, regarding the third embodiment, it will be described by focusing on the difference between that of the first embodiment.

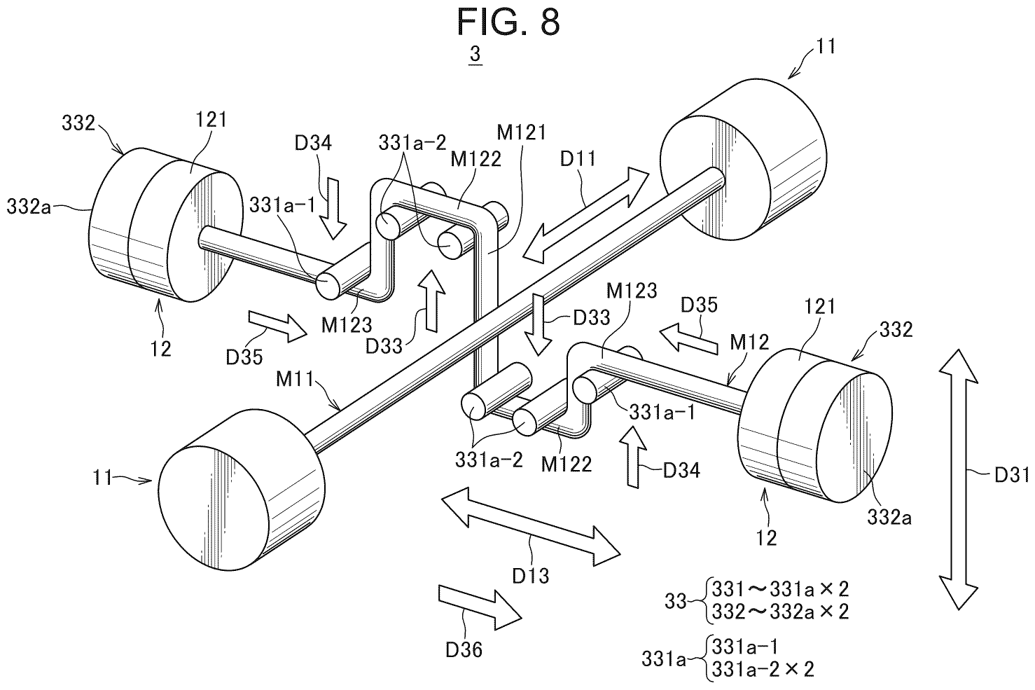

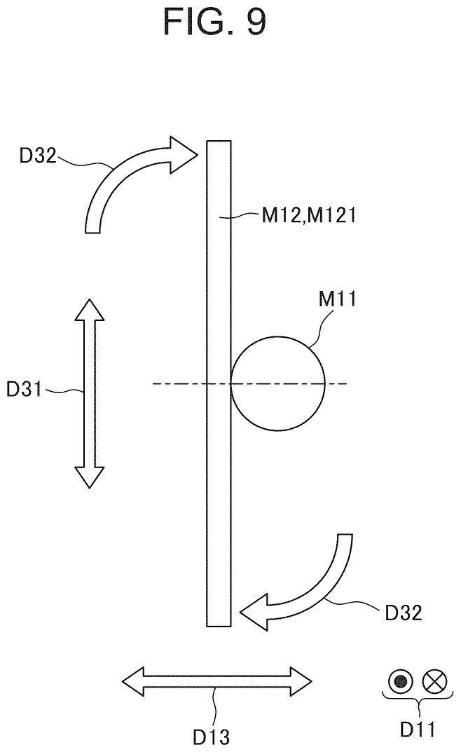

FIG. 8 is a schematic view showing the material test apparatus according to the third embodiment by focusing on the mechanism relating to the applying of the bending load from the load-applying jig to the test material. It is noted that according to FIG. 8, regarding the configuration elements being equivalent to the configuration elements shown in FIG. 1 and FIG. 2, together with FIG. 4 and FIG. 5, only those being necessary to be described will be designated to with the same reference signs in those figures, and hereinafter, the reductant description for these equivalent configuration elements will be omitted. This also applies to the following FIG. 9 to FIG. 11 to be referred.

A material test apparatus 3 according to the third embodiment is same with the above-described first embodiment in the aspect of applying the friction load, that is, it is performed by the movement mechanism 33 making the jig holding portion 12 to reciprocate. Compared with this, the applying of the bending load is performed, different from that according to the first embodiment, by the movement mechanism 33 making the load-side intersection portion M121 of the load-applying jig M12 to move as described below, and then making it to move in the bending direction D36 along the friction direction D13. For applying the bending load in this manner, the movement mechanism 33 includes a deformation movement mechanism 331 configured to deform the load-applying jig M12 to move the load-side intersection portion M121.

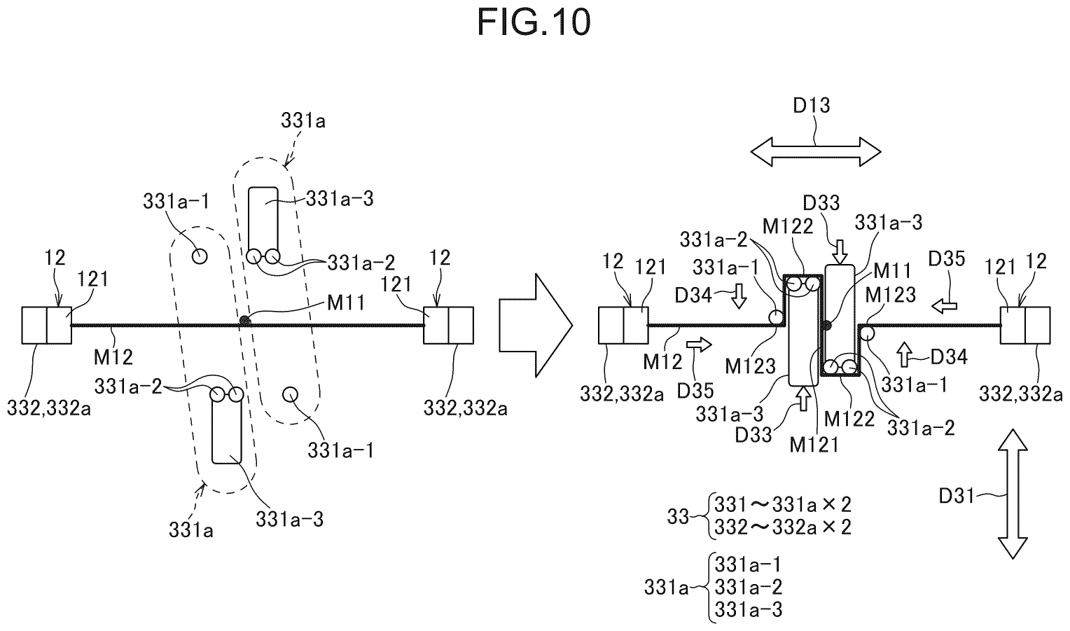

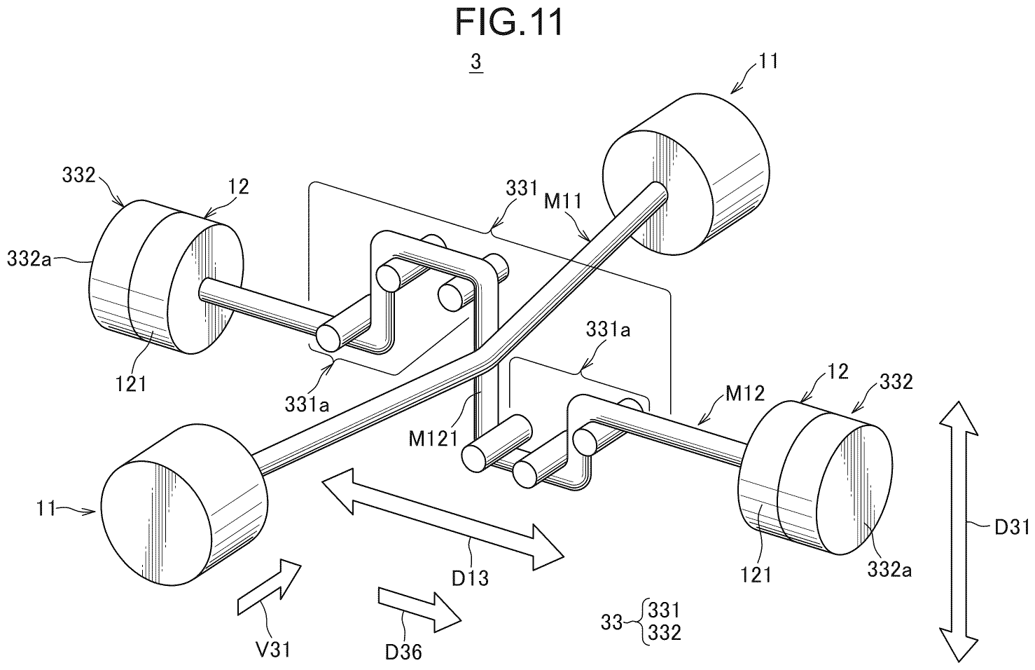

FIG. 9 is a schematic view regarding the movement of the load-side intersection portion due to the deformation of the load-applying jig shown in FIG. 8, and FIG. 10 is a schematic view showing operations of the deformation movement mechanism for performing the deformation and the movement shown in FIG. 9. It is noted that even in FIG. 9, the test material M11 is emphasized to be shown thicker than the load-applying jig M12.

The movement of the load-side intersection portion M121 refers to the movement of extending the load-side intersection portion M121 in an intersection extension direction D31 that intersects to both the target length direction D11 of the test material M11 being held by the target holding portion 11 and the friction direction D13 due to the load-applying jig M12. According to the present embodiment, due to the movement of load-side intersection portion M121 by the deformation of the load-applying jig M12, the load-side intersection portion M121 becomes a standing posture that is rotated in the rotation direction D32 at 90 degrees with respect to the posture before the deformation. Such deformation movement mechanism 331 for the deformation and movement in this manner includes a pair of fulcrum mechanism 331a for moving both end portions of the load-side intersection portion M121 in the rotation direction D32 (see FIG. 9) respectively, and each fulcrum mechanism 331a includes a pushing fulcrum 331a-1 and a push-in fulcrum 331a-2.

The pressing fulcrum 331a-1 is a fulcrum member with a round bar shape and configured to support a pressing portion M123 that is adjacent to a push-in portion M122 by the push-in fulcrum 331a-2 at the jig side such that the load-applying jig M12 does not move due to the pressing by the push-in fulcrum 331a-2. The support at this time is performed by the movement, leading to press against the pressing portion M123, in the pressing direction D34 being opposite to the push-in direction D33 by the push-in fulcrum 331a-2.

The push-in fulcrum 331a-2 is provided as two pulley members, each having a round bar shape, corresponding to one pressing fulcrum 331a-1 which are arranged to line up in the friction direction D13, and configured to push and support the push-in portion M122, corresponding to the arrangement interval thereof, in the push-in direction D33. The two push-in fulcrum 331a-2, as shown in FIG. 10, are supported by a front-end portion of a push-in block 331a-3, with a rectangular block shape, in the push-in direction D33. For each push-in block 331a-3, the two push-in fulcrum 331a-2 moves in the push-in direction D33 such that the push-in portion M122 is pushed in the push-in direction D33.

In each of the pair of fulcrum mechanism 331a, as described above, the pressing of the pressing portion M123 by the pressing fulcrum 331a-1 and the pushing of the push-in portion M122 by the two push-in fulcrum 331a-2 are performed such that the load-applying jig M12 approximately deforms into an S shape. Then, a central portion of the S shape stands up along the push-in direction D33 such that the load-side intersection portion M121 extends in the intersection extension direction D31. At this time, the load-applying jig M12 displaces along the intersection extension direction D31 at the jig-end side of each of the load-side intersection portion M121 and the two push-in portions M122, and as a result, the distance between the end portions of the load-applying jig M12 is reduced. This reduction is due to the movement mechanism 33 causing the end portions of the load-applying jig M12 to approach each other in the approaching direction D35 along the friction direction D13 which is synchronized with the movement of the pair of fulcrum mechanism 331a.

Then, according to the movement mechanism 33, the bending load is applied after the movement of the load-side intersection portion M121 by the deformation movement mechanism 331, however, according to the present embodiment, the applying of the bending load is performed by the common movement mechanism 332 as described below.

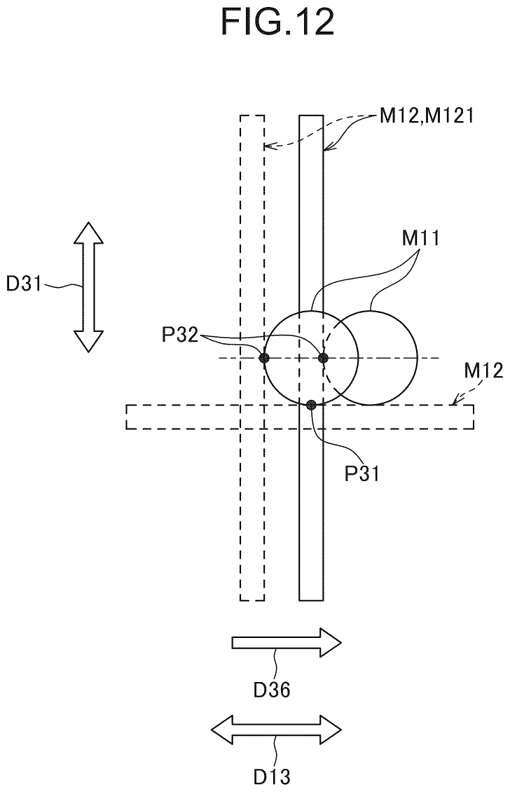

FIG. 11 is a view showing by the same schematic perspective view with FIG. 8 to show a situation in which the bending load is applied by the common movement mechanism in the material test apparatus shown in FIG. 8. Also, FIG. 12 is a view showing the aspect of applying the bending load shown in FIG. 11 when viewed from a direction of arrow V31 in FIG. 11.

The common movement mechanism 332 included in the movement mechanism 33 of the material test apparatus 3 according to the present embodiment is a mechanical portion configured to function as applying the friction load and applying the bending load. That is, the common movement mechanism 332 is configured to make the jig holding portion 12 to reciprocate in the friction direction D13 at the time of applying the friction load, and makes the jig holding portion 12 after the load-side intersection portion M121 has moved to move in the bending direction D36 along the friction direction D13 at the time of applying the bending load. This common movement mechanism 332 is equivalent to the movement mechanism for friction 131 in the above-described first embodiment and includes a pair of jig-end movement mechanism 332a connected to the pair of jig-end holding portions 121 in the jig holding portion 12 in a one-to-one correspondence.

At the time of applying the friction load, in the state in which the load-applying jig M12 is in a straight line shape before the above-described deformation movement, the pair of jig-end movement mechanism 332a are synchronized with each other to make each jig-end holding portion 121 to reciprocate in the friction direction D13. Due to this synchronized movement, the load-applying jig M12 reciprocates while making the tension from the jig holding portion 12 to be maintained, and the load-applying jig M12 rubs at the load-applied point for friction P31 (see FIG. 12) of the test material M11 that is held by the target holding portion 11 to apply the friction load.

At the time of applying the bending load performed after the deformation movement, the load-side intersection portion M121 which stands and extends in the intersection extension direction D31 is moved in the bending direction D36 in which the test material M11 is pressed. At this time, the movement of the load-side intersection portion M121 is performed by performing the overall movement with respect to the load-applying jig M12 together with the deformation movement mechanism 331 in the bending direction D36. Then, similar to the situation of applying the friction load, this overall movement is performed by the pair of jig-end movement mechanism 332a being synchronized with each other to make each jig-end holding portion 121 to move in the bending direction D36 along the friction direction D13. The load-side intersection portion M121 is pulled toward the intersection extension direction D31 by the pair of fulcrum mechanism 331a at the time of the deformation of the load-applying jig M12 and a certain amount of tension is applied to the load-side intersection portion M121. At the time of applying the bending load, this tension is maintained and the load-applying jig M12 presses the test material M11 such that the bending load is applied to the load-applied point for bending P32 (see FIG. 12). This load-applied point for bending P32 is a position shifted by 90 degrees from the load-applied point P31 in the circumferential direction around the central axis of the test material M11. When returning the bent test material M11 to the original state, the pair of jig-end movement mechanism 332a are synchronized with each other to make each jig-end holding portion 121 to move in the opposite direction to the bending direction D36 to release the bending load. Furthermore, at the time of repeating applying and releasing the bending load to bend and stretch the test material M11 in this manner, the movement in the bending direction D36 and the movement in the opposite direction are alternatively performed.

According to the material test apparatus 3 according to the above-described third embodiment, similar to the first embodiment, it is obvious that the friction test and the bending test can be performed while suppressing the changes in the test conditions due to the replacement of the apparatus or the like.

Also, according to the present embodiment, similar to the first embodiment, by moving the jig holding portion 12, it is possible to perform the friction test and the bending test at the arbitrary load-applied point for friction P31 and the load-applied point for bending P32 in the target length direction D11 in the test material M11. Furthermore, regarding the friction test, similar to the first embodiment, it is possible to perform the friction test at the arbitrary load-applied point for friction P31 in the circumferential direction by the movement mechanism 33 rotating the jig holding portion 12 (that is, the load-applying jig M12) around the central axis of the test material M11 held by the target holding portion 11. On the other hand, regarding the bending test, for example, by adjusting the relative interval between the pair of fulcrum mechanism 331a or the like, it is possible to shift the load-applied point for bending P32 in the circumferential direction by changing the standing angle of the load-side intersection portion M121. That is, regarding the bending test, it is possible to perform the bending test at the arbitrary load-applied point for bending P32 in the circumferential direction of the test material M11.

Also, according to the present embodiment, the movement mechanism 33 applies the friction load due to the reciprocation in the friction direction D13 along the jig length direction D12. Furthermore, the movement mechanism 33, when applying the bending load, moves the load-side intersection portion M121 to extend in the intersection extension direction D31 intersecting to both the target length direction D11 and the friction direction D13. Then, after the movement, the bending load is applied by moving the load-side intersection portion M121 in the bending direction D36 along the friction direction D13. According to this configuration, either of the friction direction D13 and the bending direction D36 are along the jig length direction D12 such that the movement mechanism 33 is simplified and the miniaturization of the apparatus can be realized.

Also, according to the present embodiment, the movement mechanism 33 includes the deformation movement mechanism 331 to deform the load-applying jig M12 to move the load-side intersection portion M121 and the common movement mechanism 332. The common movement mechanism 332 is the mechanical portion configured to make the jig holding portion 12 to reciprocate in the friction direction D13 at the time of applying the friction load, and after moving the load-side intersection portion M121, to move the jig holding portion 12 in the bending direction D36. According to this configuration, the reciprocation in the friction direction D13 and the movement in the bending direction D36 is performed by the common movement mechanism 332 such that it is possible to reduce the manufacturing cost due to the simplification of the mechanism.

It is noted that the above-described first embodiment to third embodiment are merely representative examples of the present invention, and the present invention is not limited thereto. That is, various modifications can be made without departing from the spirit of the present invention. Such modifications are obviously included in the scope of the present invention as long as the modifications still have the configuration of the material test apparatus of the present invention.

For example, according to the above-described first embodiment to third embodiment, as an example of the material test apparatus, the next material test apparatus 1 has been shown as an example. That is, the material test apparatus 1 in which the test material M11 with the elongated shape such as the metal wires, threads or the like having the circular cross section are applied with the friction load and the bending load by the load-applying jig M12 with the elongated shape such as the similar metal wires, threads or the like has been shown. However, the material test apparatus is not limited thereto, regarding the test material and the load-applying jig, as long as either of them has the elongated shape to be suitable to apply the friction load and the bending load, the specific cross section and the material or the like can be appropriately set.

Also, according to the above-described first embodiment to third embodiment, as examples of the test material and the load-applying jig, the test material M11 and the load-applying jig M12 whose thickness are not specified are shown as examples. In the figures, the test material M11 and the load-applying jig M12 are drawn with approximately the same thickness, or the test material M11 is emphasized to be drawn to be thicker. However, the specific thickness of the test material and the load-applying jig are not limited to any relative dimension relationship, and any possible relationship can be adopted as long as the friction load and the bending load can be suitably applied.

Also, according to the above-described first embodiment and the second embodiment, as an example of the movement mechanism, the movement mechanism 13, 23 are shown as the example for making the jig holding portion 12 to reciprocate in the friction direction D13 to apply the friction load. Also, the movement mechanism 13, 23 applies the bending load by making at least the load-side intersection portion M121 in the load-applying jig M12 to move in the bending direction D14, D24 intersecting to both the target length direction D11 and the friction direction D13. However, the movement mechanism is not limited thereto. For example, as shown in the third embodiment, the configuration making the load-side intersection portion M121 to move in the bending direction D36 along the friction direction D13 when applying the bending load is also available. As long as the movement mechanism is the mechanism that can apply the friction load and the bending load from the load-applying jig to the test material by moving at least one of the target holding portion and the jig holding portion, the specific movement direction or the like can be appropriately set. However, as described above, by changing the movement directions by the movement mechanism 13, 23 when applying the friction load and applying the bending load so as to apply each load at the same load-applied point P11, it is possible to further suppress the changes in the test conditions.

Also, according to the above-described second embodiment, as an example of the movement mechanism, the movement mechanism 23 including the movement mechanism for friction 131 and the partial movement mechanism for bending 232 configured to move the load-side intersection portion M121 only has been shown as an example. However, the movement mechanism is not limited thereto, for example, as shown in the first embodiment, there may be a configuration to move the load-applying jig M12 across the whole length thereof in the bending direction D14. However, as described above, according to the configuration of partially moving the load-side intersection portion M121 only, it is possible to realize the miniaturization of the material test apparatus 1.

Also, according to the above-described first embodiment, as an example of the movement mechanism, the movement mechanism 13 including the movement mechanism for friction 131 and the overall movement mechanism for bending 132 configured to move the whole load-applying jig M12 has been shown as an example. However, the movement mechanism is not limited thereto, for example, as shown in the second embodiment, there may be a configuration to partially move the load-side intersection portion M121 only. However, as described above, according to the configuration of moving the whole load-applying jig M12, it is possible to reduce the manufacturing cost due to the simplification of the mechanism.

Also, according to the above-described third embodiment, as an example of the movement mechanism, the movement mechanism 13 of moving the load-side intersection portion M121 so as to extend in the intersection extension direction D31, and then moving it in the bending direction D36 along the friction direction D13 has been shown. However, the movement mechanism is not limited thereto. The movement mechanism, for example, as shown in the first embodiment and the second embodiment, may be configured to make at least the load-side intersection portion M121 to move in the bending direction D14, D24 intersecting to the friction direction D13 when applying the bending load. However, as described above, by setting the friction direction D13 and the bending direction D36 as the same direction along the jig length direction D12 of the load-applying jig M12, it is possible to simplify the movement mechanism 33 to realize the miniaturization of the material test apparatus 1.

Also, according to the above-described third embodiment, as an example of the movement mechanism by setting the friction direction and the bending direction as the same direction, the movement mechanism 33 including the deformation movement mechanism 331 and the common movement mechanism 332 has been shown. The deformation movement mechanism 331 is the mechanism to deform the load-applying jig M12 and then move the load- side intersection portion M121, and the common movement mechanism 332 is the mechanism to perform both the reciprocation of the jig holding portion 12 during the period of applying the friction load and the movement of the jig holding portion 12 when applying the bending load. However, the movement mechanism to set the friction direction and the bending direction as the same direction is not limited thereto. The movement mechanism, for example, may be configured to rotate the load-applying jig M12 across the whole length to make the load-side intersection portion M121 to extend in the intersection extension direction D31 without performing the deformation of the load-applying jig M12. In this case, the mechanism to make the jig holding portion 12 to reciprocate when applying the friction load and the mechanism to move the load-applying jig M12 after the rotational movement together with the jig holding portions 12 at both ends in the bending direction are different mechanism rather than the common mechanism. However, according to the movement mechanism 33 having the above-described deformation movement mechanism 331 and the common movement mechanism 332, as described above, it is possible to reduce the manufacturing cost due to the simplification of the mechanism.

### REFERENCE SIGNS LIST

1, 1-1, 2, 3 material test apparatus
11 target holding portion
12 jig holding portion
13, 23, 33 movement mechanism
111 test-material-end holding portion
121 jig-end holding portion
131, 131-1 movement mechanism for friction
131a jig-end movement mechanism for friction
131a-1 test-material-end movement mechanism for friction
132 overall movement mechanism for bending
132a jig-end movement mechanism for bending
232 partial movement mechanism for bending
232a, 331a fulcrum mechanism
232a-1, 331a-1 pressing fulcrum
232a-2, 331a-2 push-in fulcrum
331 deformation movement mechanism
331a-3 push-in block
332 common movement mechanism
332a jig-end movement mechanism
D11 target length direction
D12 jig length direction
D13, D13-1 friction direction
D14, D24 bending direction
D31 intersection extension direction
D32 rotation direction
D33 push-in direction
D34 pressing direction
D36 bending direction
D25, D35 approaching direction
M11 test material
M12 load-applying jig
M121 load-side intersection portion
P11 load-applied point
P31 load-applied point for friction
P32 load-applied point for bending

What is claimed is:

1. A material test apparatus, comprising:
a target holding portion configured to hold a test material with an elongated shape as a test target;
a jig holding portion configured to hold a load-applying jig in a posture intersecting the test material, the load-applying jig having an elongated shape and being configured to apply a friction load of rubbing the test material and a bending load of bending the test material; and
a movement mechanism configured to apply the friction load and the bending load from the load-applying jig to the test material by moving at least one of the target holding portion or the jig holding portion.

2. The material test apparatus according to claim 1,
wherein the movement mechanism is configured to:
apply the friction load at a load-applied point in the test material intersecting with the load-applying jig by reciprocating the jig holding portion in a friction direction along a length direction of the load-applying jig, and
apply the bending load at the load-applied point in the test material by moving the load-applying jig held by the jig holding portion, at least in a load-side intersection portion thereof intersecting the test material, in a bending direction intersecting both the length direction and the friction direction of the test material.

3. The material test apparatus according to claim 2,
wherein the movement mechanism comprises:
a movement mechanism for friction configured to reciprocate the jig holding portion in the friction direction; and
an overall movement mechanism for bending configured to move the whole load-applying jig by moving the jig holding portion in the bending direction by each movement mechanism for friction.

4. The material test apparatus according to claim 2,
wherein the movement mechanism comprises:
a movement mechanism for friction configured to reciprocate the jig holding portion in the friction direction; and
a partial movement mechanism for bending configured to partially move only the load-side intersection portion in the load-applying jig in the bending direction.

5. The material test apparatus according to claim 1,
wherein the movement mechanism is configured to:
apply the friction load at a load-applied point for friction in the test material intersecting with the load-applying jig by reciprocating the jig holding portion in a friction direction along a length direction of the load-applying jig, and
apply the bending load at a load-applied point for bending in the test material by at least moving a load-side intersection portion, in the load-applying jig held by the jig holding portion, intersecting with the test material such that the load-side intersection portion extends in an intersection extension direction that intersects with both the length direction of the test material and the friction direction, and then moving the load-side intersection portion in a bending direction along the friction direction.

6. The material apparatus according to claim 5,
wherein the movement mechanism comprises:
a deformation movement mechanism configured to deform the load-applying jig to move the load-side intersection portion such that the load-side intersection portion extends in the intersection extension direction; and
a common movement mechanism configured to reciprocate the jig holding portion in the friction direction when applying the friction load as well as move the jig holding portion in the bending direction after the load-side intersection portion has moved and when applying the bending load.
